(19) United States
(12) Patent Application Publication
(10) Pub. No.: US 2024/0199824 A1
(43) Pub. Date: Jun. 20, 2024

(54) METHODS OF MANUFACTURING ARTICLES FROM CASSON COMPOSITIONS AND ARTICLES FORMED THEREFROM

(71) Applicant: SABIC GLOBAL TECHNOLOGIES B.V., BERGEN OP ZOOM (NL)

(72) Inventors: Tariq Syed, Novi, MI (US); Zahir Bashir, Trivandrum (IN); Saleh Al-Karri, Riyadh (SA); Fayez Abdullah Alfayez, Riyadh (SA); Azzedine Kioul, Riyadh (SA); Toseef Ahmed, Riyadh (SA)

(21) Appl. No.: 18/287,819

(22) PCT Filed: Apr. 20, 2022
(86) PCT No.: PCT/EP2022/060452

§ 371 Date: Oct. 20, 2023

(30) Foreign Application Priority Data
Apr. 21, 2021 (EP) 21169738.8

(51) Int. Cl. C08J 3/20; C08L 23/12; C08L 67/03

(52) U.S. Cl. CPC C08J 3/201; C08L 23/12; C08L 67/03; C08J 2323/12; C08J 2367/03; C08J 2467/03; C08L 2205/06; C08L 2205/08

(57) ABSTRACT

A method of manufacturing an article includes melt-mixing a first polymer with a second polymer and optionally an additive to form a thermoplastic composition, the first polymer having a first melting point or a first glass transition temperature T₁, the second polymer having a second melting point or a second glass transition temperature T₂ that is 30° C. to 150° C. higher than T₁: and forming the article from the thermoplastic composition at a temperature between T₁ and T₂, such as via sheet extrusion, thermoforming, pipe extrusion, extrusion molding, injection molding, extrusion molding, blow molding, compression molding, or additive manufacturing. The first polymer and the second polymer can have a volume ratio of 75:25 to 35:65 with a co-continuous morphology in the thermoplastic composition, with the second polymer providing a network for containing a melt of the first polymer.

### BACKGROUND

Many polymer based articles are manufactured by processes such as thermoforming, pipe extrusion, injection molding, and other molding processes. These processes often involve melting or softening polymers. Due to gravity and depending on the specific material used, sag can occur causing non-uniformity in the products. Desired is a method that can suppress sagging. Thus there remains a need for an improved method of making articles from polymers, and articles manufactured therefrom.

### SUMMARY

A method of manufacturing an article comprises melt-mixing a first polymer with a second polymer and optionally an additive to form a thermoplastic composition, the first polymer having a first melting point or a first glass transition temperature T₁, the second polymer having a second melting point or a second glass transition temperature T₂ that is 30° C. to 150° C. higher than T₁, the first polymer and the second polymer having a co-continuous morphology in the thermoplastic composition, with the second polymer providing a network for containing a melt of the first polymer; and forming the article from the thermoplastic composition at a temperature between T₁ and T₂, such as via sheet extrusion, thermoforming, pipe extrusion, extrusion molding, injection molding, extrusion molding, blow molding, compression molding, or additive manufacturing. The first polymer and the second polymer have a volume ratio of 75:25 to 35:65; and the article has a co-continuous morphology, with the second polymer providing a network for containing the first polymer.

A composition comprises a first polymer having a first melting point or a first glass transition temperature T₁, a second polymer having a second melting point or a second glass transition temperature T₂ that is 30° C. to 150° C. higher than T₁, and optionally an additive, wherein the first polymer and the second polymer have a co-continuous morphology, with the second polymer providing a network for containing the first polymer, and the composition is a Casson fluid.

Various examples include an article comprising the above-described composition or an article comprising a composition manufactured by the above-described method.

### BRIEF DESCRIPTION OF THE DRAWINGS

A description of the figures, which are meant to be exemplary and not limiting, is provided in which:

FIG. 1A is a graph of viscosity (pascal-second, Pa·s) versus shear rate (1/second, 1/s) for a neat polypropylene (CEx 1) at 260° C.;

FIG. 1B is a graph of viscosity (Pa·s) versus shear rate (1/s) for a compatibilized 74:20 by weight PP-PET composition (CEx 2) at 260° C.;

FIG. 1C is a graph of viscosity (Pa·s) versus shear rate (1/s) for a compatibilized 56:38 by weight PP-PET composition (Ex 3) at 260° C.;

FIG. 1D is a graph of viscosity (Pa·s) versus shear rate (1/s) for a compatibilized 47:47 by weight PP-PET composition (Ex 4) at 260° C.;

FIG. 2A shows the pellets of neat polypropylene, and compatibilized PP-PET compositions having various PP:PET weight ratios at 23° C.;

FIG. 2B shows the pellets of FIG. 2A after the pellets were heated at 200° C. for 6 minutes;

FIG. 3A is a top view of bar samples of a neat polypropylene and PP-PET compositions having various PP:PET weight ratios at room temperature;

FIG. 3B shows the bar samples of FIG. 3A after the samples were heated at 200° C. for 20 minutes;

FIGS. 4A, 4B, and 4C are scanning electron microscope (SEM) images of a 50:50 by weight PP-PET composition;

FIG. 5 shows the pellets of PP-PET compositions with various PP:PET ratios after the compositions were heated at 200° C. for 10 minutes;

FIG. 6A shows SEM images of transverse sections of PP-PET pellets having PP:PET weight ratios of 20:80 (A), 40:60 (B), 50:50 (C), and 60:40 (D);

FIG. 6B shows SEM images of machine direction sections of PP-PET pellets having PP:PET weight ratios of 20:80 (A), 40:60 (B), 50:50 (C), and 60:40 (D);

FIG. 7A shows the SEM image of 60:40 by weight PET:PP pellets extruded at 250° C.;

FIG. 7B shows the SEM image of 60:40 by weight PET:PP pellets extruded at 230° C.;

FIG. 8 shows SEM images of a 20:80 by weight PET:PC composition extruded at 270° C. (transverse section of pellet);

FIG. 9A shows a transverse view by SEM of a co-continuous morphology in 50:50 by weight PC:PET pellets extruded at 270° C.;

FIG. 9B is a transmission electron micrograph of 50:50 by weight PC:PET pellets showing a machine direction view of section of the pellets extruded at 270° C. where the PC has been stained with RuO₄ to enhance the contrast; and

FIG. 10 is a SEM image of a 60:40 by weight PET:PC composition extruded at 270° C. (transverse section of pellets).

The above described and other features are exemplified by the following Detailed Description and Examples.

### DETAILED DESCRIPTION

Casson fluids have the characteristics that they act like a solid at low shear stress (at or below critical shear stress σ₀) and do not flow; but above go after fluid flow starts, the viscosity decreases with increasing shear rate.

It was found that thermoplastic compositions exhibiting Casson fluid behaviors have high melt strength and excellent sag resistance, and are useful for making articles that are not feasible, or are challenging to make from compositions that do not show the Casson effect.

The thermoplastic compositions contain a first polymer having a first melting or glass transition temperature T₁, a second polymer having a second melting or glass transition temperature T₂, and an optional additive.

The first and second polymers can independently be crystalline polymers, or amorphous polymers. For crystalline polymers, T₁ and T₂ refer to the melting points of the polymers. For amorphous polymers, T₁ and T₂ refer to glass transition temperatures of the polymers. Glass transition temperature (T_{g}) and melting point (Tₘ) are determined by differential scanning calorimetry (DSC) as per ASTM D3418-12 with a 20 degrees Celsius per minute (° C./min) heating rate. As used herein, melting point means peak melting point. T₂ is 30° C. to 150° C. higher, or 40° C. to 120° C. higher than T_{1.}

To exhibit Casson fluid behaviors, the first polymer and the second polymer are not miscible, and form a “co-continuous morphology” in the thermoplastic compositions, with the second polymer providing a network for containing the first polymer.

As used herein, a “co-continuous morphology” is defined as a morphological structure in which two phases intertwine in such a way that both phases remain substantially continuous or continuous throughout the thermoplastic compositions or the articles. The presence of a co-continuous morphology can be determined by transmission electron microscopy (TEM) or scanning electron microscope (SEM). A composition has a co-continuous morphology if greater than or equal to 80% of the area of each phase is continuous as observed in a TEM or SEM image of the composition. In the context of the thermoplastic compositions/articles disclosed herein, the two phases include one phase of the first polymer and the other phase of the second polymer. When the thermoplastic compositions are heated to a temperature that is between T₁ and T₂, for example, above T₁ but below T₂, the second polymer provides a network for containing a melt of the first polymer.

Thermoplastic compositions having a co-continuous morphology can exhibit Casson fluid behaviors. Thermoplastic compositions with a droplet morphology (islands in a sea morphology) do not show Casson characteristics. A droplet morphology means that a discontinuous phase of one polymer is dispersed in a matrix phase of a different polymer.

The volume ratio of the first polymer relative to the second polymer is 75:25 to 35:65, preferably 70:30 to 40:60, or 65:35 to 45:55. The volume ratio can be 70:30 to 60:40 or 60:40 to 40:60. Thermoplastic compositions containing the same first and second polymers but with a volume ratio falling outside the described ranges such as 20:80 or 80:20 have a droplet morphology, and they are not Casson fluids and do not show Casson fluid behaviors.

The first polymer and the second polymer are independently selected from a polyolefin, a polycarbonate, a polyester, a polyetherimide, a polyketone, a polyamide such as nylons, a polyoxymethylene, and a polyacrylate. The first polymer, the second polymer, or both can be recycled polymers.

The polyolefin can be polypropylene and/or polyethylene. Polypropylene can be for example: a propylene homopolymer, a propylene-alpha-olefin random copolymer, preferably a propylene ethylene or a propylene C₄₋₈ alpha-olefin random copolymer, containing for example at most 5 weight percent (wt %), on the basis of the copolymer, of the ethylene or alpha-olefin, a propylene-alpha-olefin block copolymer, a hetero-phasic polypropylene copolymer, or a combination thereof.

The melt flow rate of the polypropylene can be 0.1 to 1,800 grams per 10 minutes (g/10 min) as measured in accordance with ISO 1133 (2.16 kilograms (kg), 230° C.). Preferably the melt flow rate of the polypropylene is 0.1 to 100 g/10 min as measured in accordance with ISO 1133 (2.16 kg, 230° C.).

The polyethylene can include a very low density polyethylene (VLDPE), linear low density polyethylene (LLDPE), low density polyethylene (LDPE), medium density polyethylene (MDPE), or high density polyethylene (HDPE). The polyethylene can include a mixture of at least two or more of the foregoing polyethylenes. For example the polyethylene can be a mixture of LLDPE and LDPE or it can be a mixture of two different types of LDPE.

The terms VLDPE, LDPE, LLDPE, MDPE and HDPE are known in the art. Nevertheless, very low density polyethylene can mean polyethylene with a density of less than 915 kilograms per meter cubed (kg/m3). Linear low density polyethylene and low density polyethylene can mean polyethylene with a density of from 915 to 925 kg/m³. Medium density polyethylene can mean polyethylene with a density of more than 925 kg/m³ and less than 935 kg/m³. High density polyethylene can mean polyethylene with a density of 935 kg/m³ or more.

The polyester can include a polyethylene naphthalate (PEN) or a poly(alkylene terephthalate). Combinations of different polyesters can be used. PEN is a polyester derived from naphthalene-2,6-dicarboxylic acid and ethylene glycol. The alkylene group of the poly(alkylene terephthalate) can comprise 2 to 18 carbon atoms. Examples of the alkylene group include ethylene, 1,3-propylene, 1,4-butylene, 1,5-pentylene, 1,6-hexylene, 1,4-cyclohexylene, and 1,4-cyclohexanedimethylene. In an aspect, the alkylene group is ethylene, 1,4-butylene, or a combination thereof. Preferably, the alkylene group is ethylene.

The poly(alkylene terephthalate) can be a copolyester derived from terephthalic acid (or a combination of terephthalic acid and up to 10 mole percent isophthalic acid) and a mixture comprising a linear C₂₋₆ aliphatic diol, such as ethylene glycol and/or 1,4-butylene glycol), and a C₆₋₁₂ cycloaliphatic diol, such as 1,4-cyclohexane diol, 1,4-cyclohexanedimethanol, dimethanol decalin, dimethanol bicyclooctane, 1,10-decane diol, or a combination thereof. The ester units comprising the two or more types of diols can be present in the polymer chain as random individual units or as blocks of the same type of units. Specific polyesters can include poly(1,4-cyclohexylene dimethylene co-ethylene terephthalate) (PCTG) wherein greater than 50 mole percent of the ester groups are derived from 1,4-cyclohexanedimethanol; and poly(ethylene-co-1,4-cyclohexylenedimethylene terephthalate) wherein greater than or equal to 50 mole percent of the ester groups are derived from ethylene (PETG).

The poly(alkylene terephthalate) can include small amounts (e.g., up to 10 weight percent, or up to 5 weight percent) of residues of monomers other than alkylene diols and terephthalic acid. For example, the poly(alkylene terephthalate) can include the residue of isophthalic acid. As another example, the poly(alkylene terephthalate) can comprise units derived from an aliphatic acid, such as succinic acid, glutaric acid, adipic acid, pimelic acid, 1,4-cyclohexanedicarboxylic acid, or a combination thereof.

Preferably, the poly(alkylene terephthalate) includes at least one of poly(ethylene terephthalate) or poly(butylene terephthalate). More preferably, the poly(alkylene terephthalate) includes poly(ethylene terephthalate).

As a specific example, the poly(alkylene terephthalate) is poly(ethylene terephthalate) or “PET” polymer that is obtained by polymerizing a glycol component comprising at least 70 mole percent, at least 80 mole percent, of ethylene glycol, and an acid component comprising at least 70 mole percent, at least 80 mole percent, terephthalic acid or polyester-forming derivatives therefore.

The poly(alkylene terephthalate) can have an intrinsic viscosity of 0.4 to 2.0 deciliter/gram (dL/g), as measured in a 60:40 phenol/tetrachloroethane mixture at 23° C. In an aspect, the poly(alkylene terephthalate) has an intrinsic viscosity of 0.5 to 1.5 dL/g, or 0.6 to 1.2 dL/g.

The poly(alkylene terephthalate) can have a weight average molecular weight (Mw) of 10,000 to 200,000 Daltons, or 50,000 to 150,000 Daltons, as measured by gel permeation chromatography (GPC) using polystyrene standards. The poly(alkylene terephthalate) can comprise a mixture of two or more poly(alkylene terephthalate)s having different intrinsic viscosities and/or weight average molecular weights.

“Polycarbonate” as used herein means a homopolymer or copolymer including repeating structural carbonate units of the formula (1)

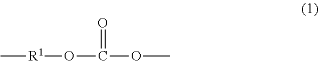

wherein at least 60 percent of the total number of R1 groups are aromatic, or each R1 contains at least one C6-30 aromatic group. Polycarbonates and their methods of manufacture are known in the art, being described, for example, in WO 2013/175448 A1, US 2014/0295363, and WO 2014/072923. Polycarbonates are manufactured from bisphenol compounds such as 2,2-bis(4-hydroxyphenyl) propane (“bisphenol-A” or “BPA”), 3,3-bis(4-hydroxyphenyl) phthalimidine, 1,1-bis(4-hydroxy-3-methylphenyl)cyclohexane, or 1,1-bis(4-hydroxyphenyl)-3,3,5-trimethylcyclohexane (isophorone), or a combination thereof can be used. In a specific aspect, the polycarbonate is a homopolymer derived from BPA; a copolymer derived from BPA and another bisphenol or dihydroxy aromatic compound such as resorcinol; or a copolymer derived from BPA and optionally another bisphenol or dihydroxyaromatic compound, and further comprising non-carbonate units, for example aromatic ester units such as resorcinol terephthalate or isophthalate, aromatic-aliphatic ester units based on C₆₋₂₀ aliphatic diacids, polysiloxane units such as polydimethylsiloxane units, or a combination thereof.

Some illustrative examples of dihydroxy compounds that can be used are described, for example, in WO 2013/175448 A1, US 2014/0295363, and WO 2014/072923. In an aspect the specific dihydroxy compound includes 2,2-bis(4-hydroxyphenyl) propane (“bisphenol A” or “BPA”). In an aspect the polycarbonate comprises a bisphenol A polycarbonate, preferably a bisphenol A polycarbonate homopolymer.

The polyacrylate means a polymer prepared from acrylate monomers and/or methacrylate monomers. Polyacrylates are also known as acrylics. A specific example of the polyacrylate is poly(methyl methacrylate) (PMMA).

Examples of first polymer/second polymer blend can include poly(butylene terephthalate)/poly(ethylene terephthalate), polyethylene naphthalate/poly(ethylene terephthalate), polyethylene/poly(ethylene terephthalate), polyethylene/poly(butylene terephthalate), polyethylene naphthalate/poly(butylene terephthalate), polypropylene/polyamide, polypropylene/polyketone, polyethylene/polyamides, and polyethylene/polyoxymethylene.

In an aspect, the first polymer comprises at least one of a polypropylene, or a polycarbonate; and the second polymer comprises a poly(ethylene terephthalate). As a specific example, the first polymer comprises a polypropylene, and the second polymer comprises a poly(ethylene terephthalate). The polypropylene and the poly(ethylene terephthalate) can have a volume ratio of 75:25 to 45:55, preferably 70:30 to 50:50, or 70:30 to 60:40. Polypropylene, poly(ethylene terephthalate), or both can be recycled polymers. Polypropylene and poly(ethylene terephthalate) are among the largest streams of waste polymers from the packaging industry. There is much effort devoted to separation and recycling. Separating is a costly step in recycling. Using the methods as described herein, thermoplastic compositions containing recycled polypropylene and recycled poly(ethylene terephthalate) can be used to make articles with suppressed sagging during melt processing and intermediate fabrication steps such as thermforming, pipe extrusion and orientation. There is no need to separate polypropylene and poly(ethylene terephthalate), and the discovery allows for the manufacture of articles with significant cost savings.

As another specific example, the first polymer comprises a polycarbonate and the second polymer comprises a poly(ethylene terephthalate). The polycarbonate and the poly(ethylene terephthalate) can have a volume ratio of 70:30 to 30:70, or 65:35 to 35:65, or 60:40 to 40:60.

In the thermoplastic compositions, a sum of the weight of the first and second polymers can be 70 to 100 wt %, 80 to 99 wt %, or 80 to 95 wt %, based on the total weight of the thermoplastic compositions.

The thermoplastic compositions can further contain up to 15 wt %, 0.5 to 15 wt %, or 5 wt % to 15 wt % of an additive based on the total weight of the thermoplastic compositions. The additive includes at least one of a compatibilizer, a filler, a dye, a pigment, an antioxidant, an ultra-violet absorber, an infrared absorber, a flame retardant, a mold release agent, or an impact modifier.

Optionally the additive includes at least a functionalized polyolefin. The functionalized polyolefin can serve as an impact modifier, an compatibilizer, or a combination thereof. The functionalized polyolefin can be a copolymer of ethylene and/or propylene and one or more unsaturated polar monomers, which can include: C₁₋₈ alkyl (meth)acrylates, such as methyl, ethyl, propyl, butyl, 2-ethylhexyl, isobutyl and cyclohexyl (meth)acrylates; unsaturated carboxylic acids, their salts and their anhydrides, such as acrylic acid, methacrylic acid, maleic anhydride, itaconic anhydride and citraconic anhydride; unsaturated epoxides, such as aliphatic glycidyl esters and ethers such as allyl glycidyl ether, vinyl glycidyl ether, glycidyl maleate and glycidyl itaconate, glycidyl acrylate and glycidyl methacrylate, and also alicyclic glycidyl esters and ethers; and vinyl esters of saturated carboxylic acids, such as vinyl acetate, vinyl propionate and vinyl butyrate.

Examples of functionalized polyolefin formed by copolymerization include ethylene/acrylic acid (“EAA”) copolymers and ethylene/methacrylic acid (“EMAA”) copolymers. Commercially available functionalized polyolefins formed by copolymerization include: PRIMACOR polymers available from the Dow Chemical Company, which are EAA copolymers; NUCREL polymers available from the Dow Chemical Company, which are EMAA polymers; and LOTADER 8900 available from the SK Global Chemical, which is a terpolymer of ethylene, methyl acrylate and glycidyl methacrylate.

Examples of an acid or acid anhydride modified polyolefin include a polyethylene and/or a polypropylene that is/are graft-modified with a maleic acid or a maleic anhydride. A commercially available acid anhydride modified polyolefin is OREVAC 18360, which is available from the SK Global Chemical. OREVAC 18360 is a maleic anhydride modified LLDPE having a density of 0.914 g/cm3 and a melt temperature of 120° C. Another example of a commercially available acid modified polyolefin is OREVAC CA 100, which is available from the SK Global Chemical. OREVAC CA 100 is a maleic anhydride modified polypropylene having a density of 0.905 g/cm³ and a melt temperature of 167° C. Still another example of a commercially available acid modified polyolefin includes EXXELOR PO 1015, which is available from ExxonMobil Chemical. EXXELOR PO 1015 is a maleic anhydride functionalized polypropylene copolymer.

The first polymer, the second polymer, and the optional additive can be melt-mixed to form the thermoplastic compositions having a co-continuous framework. Melt-mixing means that the first polymer, the second polymer, and the optional additive are mixed at a temperature higher than that necessary to cause the mixed compositions to flow. The melt-mixing can be conducted at a temperature that is equal to or higher than T₂, for example, between T₂ and T₂+30° C., between T₂ and T₂+20° C., or between T₂ and T₂+10° C.

Before melt-mixing, the first polymer, the second polymer, and the optional additive may be pre-mixed in a mixer, for example a dry blender as may be purchased from Henschel, in the form of a powder, granules, pellets, or a combination thereof.

Melt-mixing may be conducted in a reactor, an extruder, or other apparatus known to a person skilled in the art. When using an extruder, an extruder such as a twin-screw extruder can be used. The temperature can vary through the different zones of the extruder as needed. Preferably, the temperature in the extruder is equal to or higher than T_{2,} , for example, the temperature in the extruder can vary from T₂ to T₂+30° C., from T₂ to T₂+20° C., or from T₂ to T₂+10° C. The screw speed of the extruder can be varied from 100 to 400 revolutions per minute (rpm).

The melt-mixed compositions such as an extrudate can be quenched in a water bath to form the thermoplastic compositions having a co-continuous morphology. Conversely, the co-continuous morphology can be formed by further processing the melt-mixed compositions at a temperature between T₁ and T₂, for example at a temperature above T₁ and at or below T₂. The thermoplastic compositions can be in a pellet form.

The thermoplastic compositions with a co-continuous morphology can have Casson fluid characteristics. The thermoplastic compositions exhibit no flow at low shear rates below a critical shear rate and shows a shear thinning behavior at high shear rates above the critical shear rate. The critical shear rate can be determined by selecting a temperature between T₁ and T₂, extruding a composition containing the first polymer, the second polymer, and the optional additive in a capillary rheometer, and determining the shear rate where the composition stops flowing. The determined shear rate is the critical shear rate for the selected temperature.

Since the thermoplastic compositions are Casson fluids exhibiting a shear thinning behavior at high shear rates above the critical shear rate, the first polymer, the second polymer, and the optional additive can be melt-mixed at high shear rates to allow flow, which facilitates the processing and contributes to the formation of thermoplastic compositions with a co-continuous morphology.

In addition, since the thermoplastic compositions are Casson fluids exhibiting no flow at low shear rates below a critical shear rate, the thermoplastic compositions can have high melt strength, and excellent slump or sag resistance. As used herein, melt strength refers to the maximum value of the drawing force that is realized at break of the thermoplastic compositions. The discovery allows for the manufacture of products that are not feasible, or which are problematic to make from compositions containing the same first polymer and/or the same second polymer but do not show Casson fluid behaviors.

Various articles can be formed from the thermoplastic compositions having a co-continuous morphology. To make the articles, the thermoplastic compositions can be processed at a temperature between T₁ and T₂, preferably above T₁ and below T₂, for example between T₁+5° C. and T₂−5° C., between T₁+10° C. and T₂−10° C., or between T₁+15° C. and T₂−10° C. Forming the articles comprises sheet extrusion, thermoforming, pipe extrusion, extrusion blow molding, injection molding, extrusion molding, below molding, compression molding, or additive manufacturing such as fusion deposition modelling (FDM) method, optionally in combination with biaxial stretching, tape or film drawing, or tape slitting.

When the thermoplastic compositions are extruded, the extrusion temperature can be from T₂−5° C. to T₂−30° C., from T₂−5° C. to T₂−20° C., or from T₂−10° C. to T₂−20° C. Processing the thermoplastic compositions under the described temperature ranges can maintain the co-continuous morphology of the first polymer and the second polymer in the formed articles.

More than one process can be used to form the articles from the thermoplastic compositions. In an aspect, forming the articles comprises extruding or molding the thermoplastic compositions having a co-continuous morphology into a preform such as a sheet or a pipe at a temperature between T₁ and T₂, for example between T₂−5° C. and T₂−30° C., between T₂−5° C. and T₂−20° C., or between T₂−10° C. and T₂−20° C.; and processing the preform at a temperature of T₁+10° C. to T₁+50° C., or T₁+10° C. to T₂+40ºC, or T₁+10° C. to T₂+30° C. thereby forming the articles.

The first and second polymers in the preform have a co-continuous morphology; and the preform exhibits Casson fluid behaviors.

When the preform is a sheet, the sheet can be thermoformed to form the articles. When the preform is a pipe, the pipe can be subjected to an orienting process such as biaxial orientation by die drawing to form the articles.

As a specific example, when the thermoplastic compositions comprise polypropylene as the first polymer and poly(ethylene terephthalate) as the second polymer, articles can be formed from the thermoplastic compositions having a co-continuous morphology via a process such as injection molding, extrusion molding, blow molding, compression molding, pipe extrusion, or sheet extrusion, at 230 to 260° C. or 240 to 260° C. Under the described processing temperature ranges, the poly(ethylene terephthalate) network can be preserved, thereby obtaining the melt strength and sag resistance. When the extrusion temperature is below 230° C., high shear may break the poly(ethylene terephthalate) network and cause the poly(ethylene terephthalate) to agglomerate and the polypropylene to flow out and separate.

When thermoforming is used to make articles containing polypropylene, poly(ethylene terephthalate), and the optional additive, there can be three steps. First the first polymer, the second polymer, and the optional additive are melt mixed at 265 to 280° C. or about 270° C. to form a thermoplastic composition having a co-continuous morphology. Then the thermoplastic composition is extruded at 240 to 260° C. to form a sheet preserving a co-continuous framework. The sheet can then be thermoformed at 180 to 200° C. to make the articles.

The articles that can be manufactured by the described method are not particularly limited. The first polymer and the second polymer can have a co-continuous morphology in the formed article. The articles can show Casson fluid characteristics, exhibiting no flow at low shear rates below a critical shear rate and a shear thinning behavior at high shear rates above the critical shear rate. Articles may be automotive interior articles, automotive exterior articles, household appliances, pipes, films, sheets, tapes including slit tapes, pellets, containers, and infuse bags.

The Casson compositions are further illustrated by the following non-limiting examples. Unless indicated otherwise, in the disclosure, the ratios of polymers refer to weight ratios.

### EXAMPLES

The materials used in the Examples are described in Table 1A.

TABLE 1A

| Component | Chemical Description | Source |
|---|---|---|
| PP | Polypropylene, Mw of about 699,519 g/mol as determined by | SABIC |
| | GPC using polystyrene standards, a molecular weight | |
| | distribution of 5.33, density of 0.905 g/cm³, melt index of 0.13 | |
| | g/10 min - at 230° C./2.16 kg, and melting point (T_{m, pp}) of 165° C. | |
| | (also referred to as “PPHMwt”) | |
| PET | Poly(ethylene terephthalate), inherent viscosity of 1 dL/g, | SABIC |
| | density of 1.4 g/cm³, melting endpoint (T_{m, PET}) of 265° C. | |
| PC | Bisphenol A polycarbonate homopolymer, Tg (T_{g, PC}) of 150° C. | SABIC |
| Additives | A combination of a random terpolymer of ethylene, acrylic | ARKEMA |
| | ester and glycidyl methacrylate (LOTADER AX 8900) and | |
| | maleic anhydride grafted polypropylene (OREVAC CA 100) | |

The tests performed are summarized in Table 1B, where mm/min stands for millimeters per minute, kJ/m² stands for kilojoules per meter squared, and MPa stands for megapascals.

TABLE 1B

| Test Description | Test | Units |
|---|---|---|
| Notched Izod Impact, @23° C. | ISO 527-1: 2019 | kJ/m² |
| Tensile modulus 1 mm/min, @23° C. | ISO 527-1: 2019 | MPa |
| Tensile strength @ break 50 mm/min, @23° C. | ISO 527-1: 2019 | MPa |
| Tensile strength @ yield 50 mm/min, @23° C. | ISO 527-1: 2019 | MPa |
| Elongation @ break 50 mm/min, @23° C. | ISO 527-1: 2019 | % |
| Elongation @ yield, 50 mm/min, @23° C. | ISO 527: 1-2019 | % |
| Flexural Modulus, 5 mm/min, @23° C. | ISO 178: 2019 | MPa |
| Flexural Strength, 5 mm/min, @23° C. | ISO 178: 2019 | MPa |

### PET-PP Compatibilized Compositions

PP pellets, PET powders, and the additives as shown in Table 2 were blended in an extruder at 230° C. and pelletized. Alternatively, if the PET is in a pellet form, PP, PET, and the additives can be blended at 270° C. The two component additive was 5% LOTADER AX8900 impact modifier plus 1% OREVAC CA100 compatibilizer.

TABLE 2

| Component | Unit | CEx 1 | CEx 2 | Ex 3 | Ex 4 | CEx 5 |
|---|---|---|---|---|---|---|
| PP | Wt % | 100 | 74 | 56 | 47 | |
| PET | Wt % | | 20 | 38 | 47 | 100 |
| Total Additive | Wt % | | 6 | 6 | 6 | |
| PP:PET by weight | | | 74:20 | 56:38 | 50:50 | |

For blends, the actual effect of morphology depends not on the weight percentage, but on the volume percentage. The volume fractions of PP relative to PET in the compositions of Table 2 are shown in Table 3. The mass fraction and volume fractions are PP relative to PET without regard to the compatibilizer, which was 6 wt % in the formulation (Table 2).

TABLE 3

| | Ex. 4 | | Ex. 3 | | CEx 2 | |
|---|---|---|---|---|---|---|
| Material | PP | PET | PP | PET | PP | PET |
| Weight % | 47 | 47 | 56 | 38 | 74 | 20 |
| Mass fraction | 0.50 | 0.50 | 0.60 | 0.40 | 0.79 | 0.21 |
| Density g/cm³ | 0.905 | 1.34 | 0.905 | 1.34 | 0.905 | 1.34 |
| Volume fraction | 0.60 | 0.40 | 0.69 | 0.31 | 0.85 | 0.15 |

### PET-PP Compatibilized Compositions: Rheology Properties Measured in a Capillary Rheometer

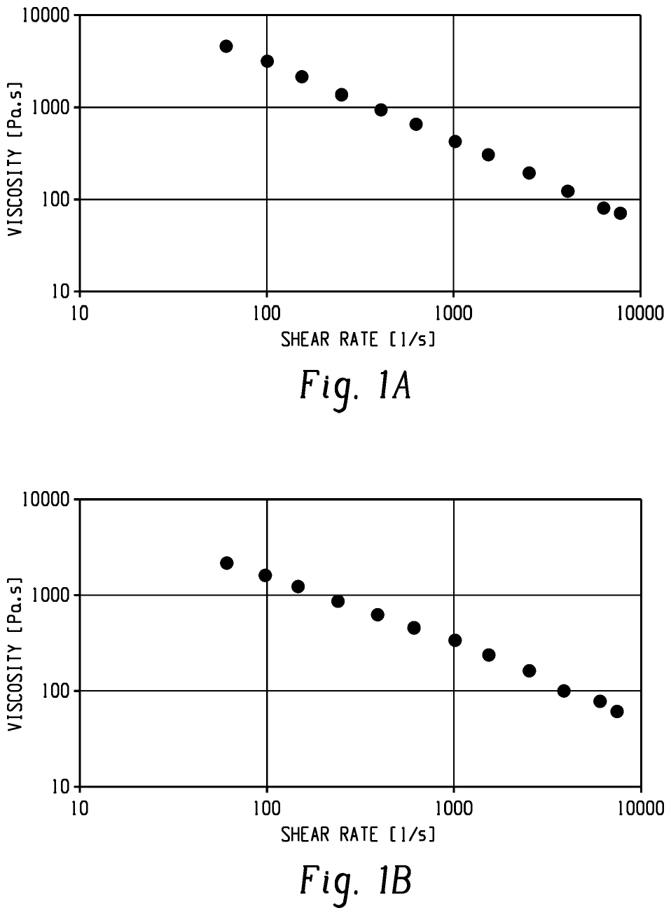

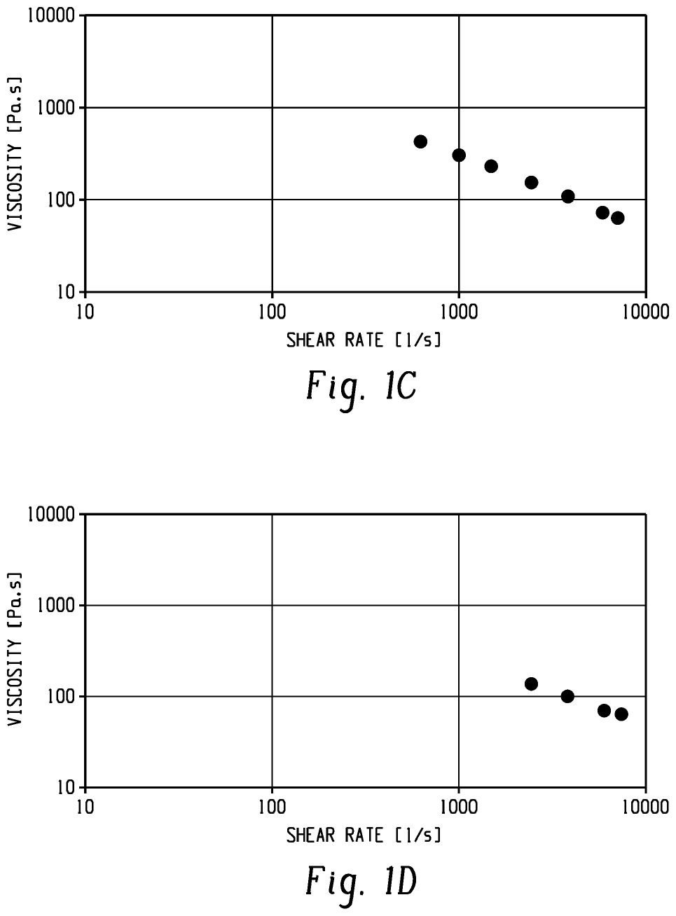

The shear viscosity curves of the compositions of Table 2 were acquired in a capillary rheometer at 260° C. The results are shown in FIGS. 1A-1D.

FIG. 1A and FIG. 1B indicate that neat polypropylene (CEx 1) and the 74:20 PP:PET composition (CEx 2), respectively, flow at all shear rates from under 100 to 10,000 s⁻¹ at 260° C. The viscosity in the lowest shear rates, 0 to 100 s⁻¹, is also obtainable by using an oscillatory parallel plate rheometer. Thus the compositions of CEx 1 and CEx 2 do not show Casson fluid behavior.

As shown in FIG. 1C and FIG. 1D, for 56:38 PP-PET composition (Ex 3) and 47:47 PP-PET composition (Ex 4), flow can be observed at shear rates of over 1000 s⁻¹ at 260° C.; but at lower shear rates, there is no flow. Thus, the 56:38 and 47:47 PP-PET compositions show Casson fluid behavior as they flow only at high shear stresses and high shear rates, but do not flow at lower shear stresses and lower shear rates. Further, Casson fluids, when they flow at high shear rates, they show shear thinning, and this is seen in FIGS. 1C and 1D.

PET-PP Compatibilized Compositions: Stickability of Pellets at a Temperature Between T_{m,PP} and T_{m,PET}

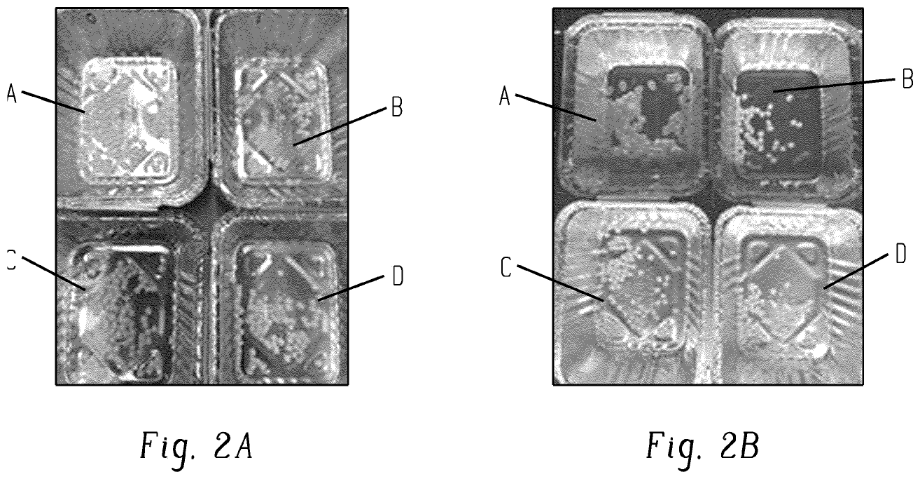

The stickability test (like the sag test) is a simple measure of compositions with Casson properties. A test was performed to determine the stickability of neat polypropylene and compatibilized PP-PET compositions after the compositions were heated at a temperature between T_{m,PP} and T_{m,PET}. FIG. 2A shows the pellets at 23° C.; and FIG. 2B shows the pellets after being heated at 200° C.for 6 minutes.

After the heat treatment, the neat polypropylene pellets (CEx 1, A) melted completely and flowed under its own weight. The compatibilized 74:20 PP-PET pellets (CEx 2, B) showed some sticking but the outline of the pellets could still be seen. The pellets of compatibilized 56:38 PP-PET composition (Ex 3, C) and the compatibilized 47:47 PP-PET composition (Ex 4, D) showed shape retention and no sticking, even though 69 vol % (Ex 3, C) or 60 volume % (Ex 4, D) of the pellets was molten polypropylene. The shape retention and non-stickability behavior of the pellets is consistent with the compositions of Ex 3 (C) and Ex 4 (D) being a Casson fluid composition—there is no flow at low shear stress due to gravity at a temperature between T_{m.PP} and T_{m.PET}.

### PET-PP Compatibilized Compositions: Mechanical Properties

The pellets of neat polypropylene (CEx 1), neat PET (CEx 5) and compatibilized PP-PET compositions (CEx 2, Ex 3, and Ex 4) were injection molded at 230° C. Tensile bars were obtained without defects. The mechanical properties of the tensile bars are shown in Table 4.

TABLE 4

| Properties | Unit | CEx 1 | CEx 2 | Ex 3 | Ex 4 | CEx 5 |
|---|---|---|---|---|---|---|
| Notched Izod Impact | kJ/m² | 3.8 | 2.8 | 2 | 1.9 | 3.6 |
| Tensile modulus | MPa | 1168 | 1162 | 1416 | 1460 | 2460 |
| Tensile strength @ break | MPa | 29 | 28.4 | 26.9 | | 41.5 |
| Tensile strength @ yield | MPa | 17 | 17.4 | 26.2 | 28.6 | 65 |
| Elongation @ yield | % | 12 | 12.4 | 7.4 | | 2.3 |
| Elongation @ break | % | 55 | 84.6 | 9.6 | 3.4 | |
| Flexural Modulus | MPa | 1043 | 1117 | 1363 | 1453 | 2250 |
| Flexural Strength | MPa | 33 | 33 | 40 | 38 | 64.8 |
| Density | g/cm³ | 0.899 | 0.9686 | 1.0418 | 1.0758 | 1.3-1.4 |

PET-PP Compatibilized Compositions: Sag Test on Injection Molded Bars Between T_{m,PP} and T_{m,PET}

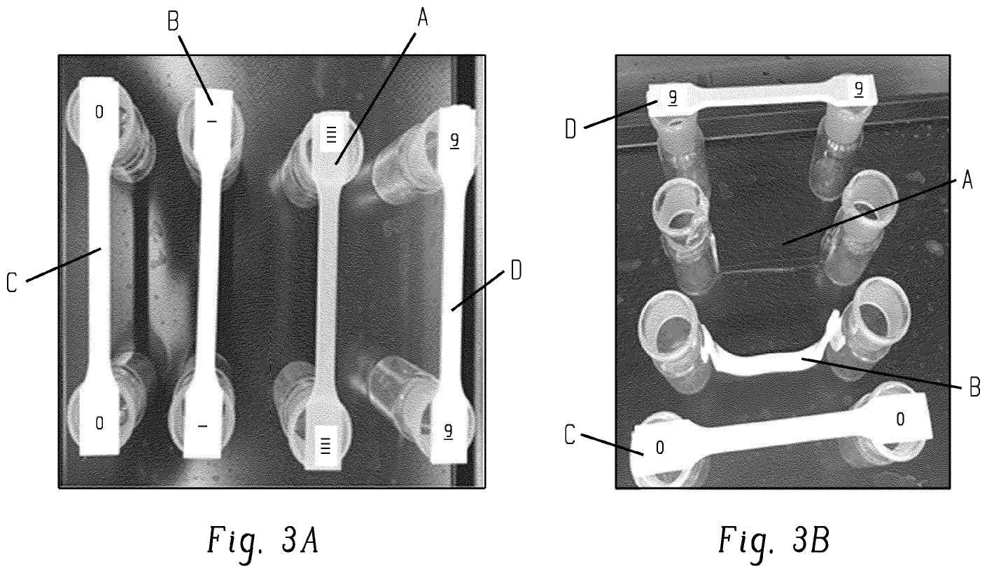

A sag test was performed. Tensile bars of CEx 1, CEx 2, Ex 3, and Ex 4 compositions were placed on end supports as shown in FIG. 3A. Then the tensile bars were placed in an oven at 200° C. for 20 minutes. FIG. 3B shows the tensile bars after the heat treatment.

The neat polypropylene bar (CEx 1, A) melted completely and became a transparent liquid. The bar made from the compatibilized 74:20 PP-PET composition (CEx 2, B) lost its shape and showed sagging. In contrast, the bars made from the compatibilized 56:38 PP-PET composition (Ex 3, C) and the compatibilized 47:47 PP-PET composition (Ex 4, D) did not show any sagging. The property arising from the Casson behavior would be beneficial for thermoforming of sheets and extrusion of large pipes.

PET-PP Compatibilized Compositions: Morphology Features that Show Casson Fluid Behavior

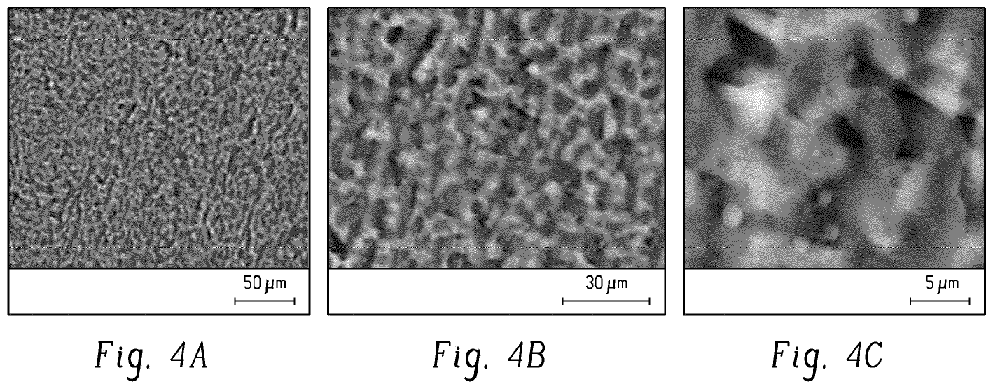

PP and PET are immiscible at all weight ratios. The SEM images of the compatibilized 47:47 PP-PET composition (Ex 4) are shown in FIGS. 4A-4C. The composition has a co-continuous morphology where PET and PP form an inter-mingled network. The PET domains are lighter. Due to the effect of the compatibilizer, the boundaries between the PET and PP are fuzzy. Without wishing to be bound by theory, it is believed that at a temperature at or above the melting point of PP and below the melting point of PET, the PP is molten but cannot flow at low shear stresses as the PP melt is trapped in a solid PET network. The PET network can be broken at high shear rates allowing flow. In comparison, 80:20 PP-PET and 20:80 PP-PET compositions have an ‘island in the sea’ morphology, where droplets of one polymer are dispersed in a matrix of the other polymer. The islands are globular. Compositions having the ‘island in the sea’ morphology do not show Casson fluid behaviors. Without wishing to be bound by theory, it is believed that compositions with the ‘island in the sea’ morphology can act like a polymer with filled glass spheres, where the globules of the higher melting polymer correspond to glass spheres. Thus extruding 80:20 PP-PET blend at 200° C. would be like extruding a PP filled with 20% glass spheres—it will be a bit more viscous than PP, and in addition it will flow at all shear rates including low shear rates.

PET-PP Blends without Compatibilizers

The work with PET-PP blends without compatibilizers was done with PP having a density of 905 kg/m³ and a melt index of 3.1 at 230° C./2.16 kg. (also referred to as “standard PP”) These examples show that the morphology and Casson behavior are not dependent on the molecular weights of the polymers or the presence of compatibilizers or impact modifiers.

PP pellets and PET pellets were blended in an extruder at 270° C. and pelletized. All the effects observed with compatibilized PET-PP compositions were also observed in uncompatibilized PET-PP compositions, except that without compatibilization the co-continuous morphology can be distinctly and easily seen in the microscope due to higher contrast.

Stickability of uncompatibilized PET-PP pellets at a temperature between T_{m,PP} and T_{m,PET}

The non-stickability of pellets was also observed when a polypropylene with a density 905 kg/m³, and a melt index of 3.1 g/10 min, measured at 230° C./2.16 kg was used in combination with PET to provide compositions having a co-continuous morphology.

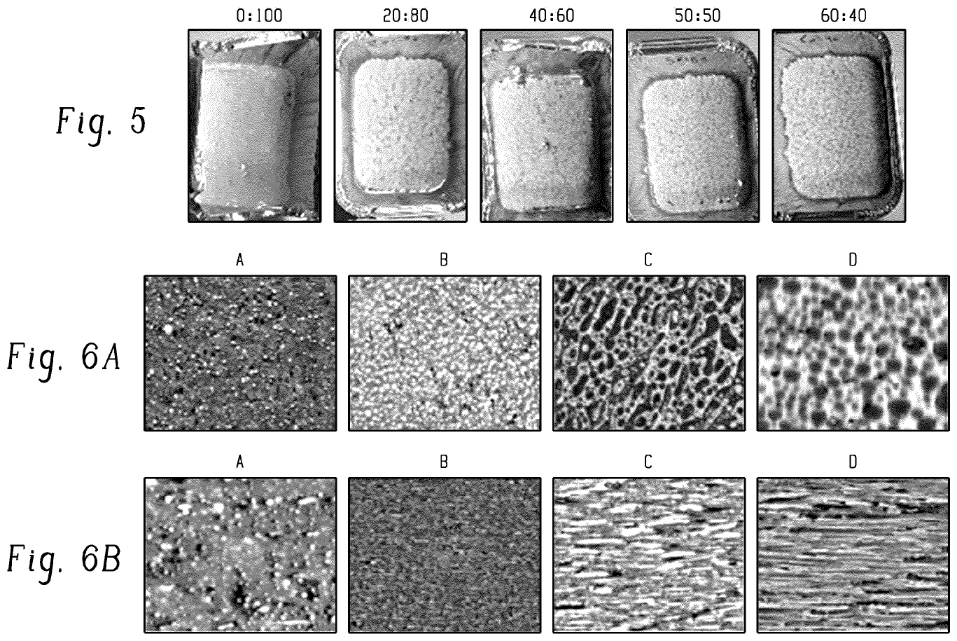

Pellets of neat PP and uncompatibilized PP-PET compositions were placed in an oven at 200° C. for 10 minutes. FIG. 5 shows the pellets after the heat treatment. As shown in FIG. 5, neat PP pellets melted and flowed into a puddle. The uncompatibilized 20:80 PET-PP composition by weight showed partial melting and agglomeration; this composition does not have Casson rheology. On the top, the outline of the pellets can be seen for the 20:80 PET-PP; however, the ensemble of pellets was caked into one piece conforming to the shape of the aluminum tray, and the pellets could not be separated by rubbing. That is, there was sticking and full agglomeration for the 20:80 PET-PP. The 40:60, 50:50 and 60:40 PET-PP compositions by weight showed shape retention; in these cases, the sticking was mild; and any minor agglomerates were broken by light rubbing or shaking. Thus the compositions with a PET:PP weight ratio of 40:60 to 60:40 (volume ratio is 31: 69 to 50:50) also show Casson fluid behavior at a temperature between T_{m,PP} and T_{m,PET}, even with standard molecular weight PP and without compatibilizer. The volume ratio was obtained by calculating the volume from the mass, taking the density of the PET as 1.37 g/cm³ (about 30% crystallinity) and that of PP as 0.905 g/cm³.

Forming Articles from PET-PP Blends having a Co-Continuous Morphology at a temperature between T_{m,PP} and T_{m,PET}

First and second extrusions are described. The first extrusion, which is a specific example of melt mixing, is conducted at a temperature that is above the higher of the two polymer melting temperatures. From the first extrusion, one makes a thermoplastic composition such as blend pellets having a co-continuous morphology. The blend pellets can be extruded again (second extrusion) to make articles such as pipes and sheets. In some cases, it might be possible to make the articles directly from the first extrusion. However, to maintain the network and prevent enlargement of the PET domains after the end of shear flow, the cooling has to be quick and sufficient. Thus, the preferred method of making articles is by a second extrusion of blend pellets made by a first extrusion at a temperature that is above T_{m,PET}. The PP-PET blend pellets can be re-extruded (second extrusion) at a temperature between T_{m,PET} and T_{m,PP}, such that higher melt strength is obtained from the maintained pre-existing PET network. Experiments showed that for the PP-PET pellets exhibiting Casson behaviors, the second extrusion could be conducted at 260° C., 250° C. or 240° C. Although the blend pellets extruded even at 230° C., high shear stresses can start breaking the PET network, and the PET domains get very large, leaving large open channels for the PP melt to flow out, thereby causing two melts to separate from each other. Hence, the second extrusion of PP-PET blend pellets can be conducted at 240 to 260° C., preferably 245° C. to 255° C. to form the final articles or unoriented articles which can be further processed.

There can be an additional process applied to make an oriented article. For example, after pellet formation and extrusion to form a sheet, the extruded sheet can be thermoformed. The thermoforming temperature can be a temperature closer to the melting point of the lower melting polymer. For example the thermoforming temperature can be 180° C. for a sheet comprising PP and PET, where the sag resistance would be a benefit. For pipes, an orienting process such as biaxial orientation by die drawing can optionally be performed. In this case, the process can be conducted at a temperature nearer the melting point of the lower melting component, that is T_{m,PP}.

The 40:60, 50:50, and 60:40 PET-PP pellets had no flow at low shear at a temperature between T_{m,PP} and T_{m,PET}, as indicated by the pellet sticking test in FIG. 5. Nonetheless, these pellets can be re-extruded (high shear rate conditions apply in the extruder) smoothly at 260, 250, 240, and 230° C. to form strands. The second extrusion of the strand was continuous without breakage even at 260, 250, 240, and 230° C., and hence sheets and pipes can be extruded continuously in a second extrusion using pellets made in a first extrusion (melt-mixing), as described here. Thus at high shear stresses and shear rates, the 40:60, 50:50, and 60:40 PET-PP compositions can flow at a temperature between T_{m,PP} and T_{m,PET}. However, for the second extrusion between T_{m,PP} and T_{m,PET} it is preferred to extrude at the higher end of the interval, that is 250° C. rather than 230° C. or 220° C. At lower temperatures for a second extrusion, the shear stresses increase, and the increased shear stresses may partially break up the co-continuous PET network causing agglomeration or enlargement of PET domains, which leads to the PP melt having more open channels to flow out (destruction of the co-continuous PET network). Thus, if pipe extrusion was performed using pre-made PET-PP pellets, it is preferable to extrude at a temperature just below the PET's melting temperature (T_{m,PET}), for example 250° C. or 240° C. For thermoforming, the sheet extrusion with a composition having Casson fluid properties, for example 50:50 PET-PP, is conducted at a temperature that is above T_{m PET}, for example at 270° C.; and the secondary operation (thermoforming) can be performed at a temperature nearer T_{m, PP}, for example at 190° C.

### Morphology of the Uncompatibilized PP-PET Compositions

As shown in FIGS. 6A and 6B, compositions such as 20:80 PET-PP have an ‘island in the sea’ morphology, where droplets of PP are dispersed in a matrix of PET. Compositions with such a morphology do not show Casson fluids rheology at a temperature between T_{m,PP} and T_{m,PET}.

In comparison, compositions such as 40:60, 50:50 and 60:40 by weight of PET-PP have a co-continuous morphology. The compositions without the compatibilizer show sharper boundaries between the PET and PP domains compared with the compatibilized blends (compare FIG. 6A and FIG. 6B with FIG. 4), hence the morphology behind the Casson blends is more easily visualized. For the 60:40 PET-PP composition, the transverse direction (TD) view in FIG. 6A of a pellet made from an extruded strand shows a honeycomb like structure of the PET with the PP trapped inside (the white areas are the PET walls of the honeycomb, while the PP is shown in the dark areas). The machine direction (MD) view in FIG. 6B shows a center slice across the long axis of the pellet. The PP is held in narrow tubes of PET, and the PP melt will be held by capillary forces within the PET tubes if heated to a temperature between T_{m,PP} and T_{m,PET}. In other words, the PP will melt but will not flow out. Hence, PP-PET compositions with a weight ratio of PP to PET of about 50:50 will show Casson solid behavior at a temperature between T_{m,PP} and T_{m,PET}. In other words, although more than 50 vol % of the composition is molten PP, the composition behaves as a solid at low shear. At higher shear rates, the PET honeycomb or net is broken, and the composition can flow. Thus, in a screw extruder, the 50:50 or 60:40 by weight of PP-PET pellets could be re-extruded (second extrusion) at a temperature between T_{m,PP} and T_{m,PET}, but preferably nearer T_{m,PET} than T_{m,PP}, to minimize breaking up the co-continuous structure which can cause agglomeration of the PET domains, leading to free pathways for the PP melt to flow out.

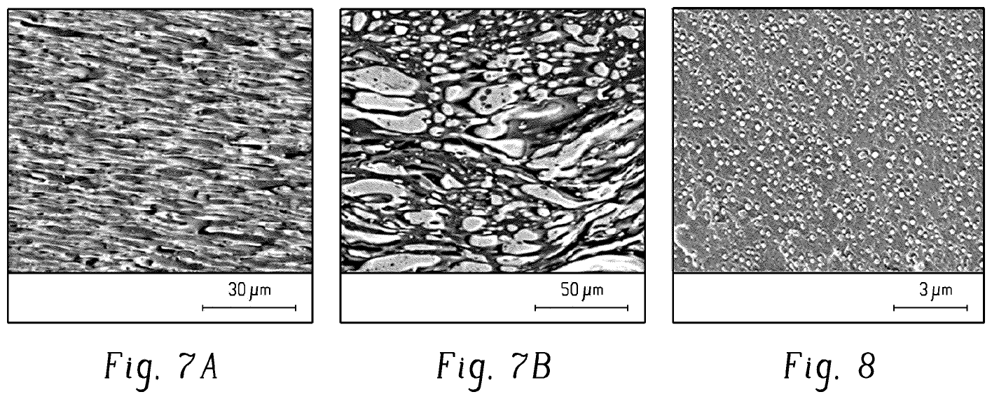

The effect of a second extrusion at 250° C. of a 60:40 PET (maintenance of PET network) and at 230° C. (destruction of the PET network with enlargement of the PET domains) is shown in FIGS. 7A and 7B respectively. FIG. 7A shows the SEM image of 60:40 PET:PP pellets extruded at 250° C. (pellets in a second extrusion). The image shows that the co-continuous network is maintained in the pellets of the second extrusion. PET is in the white domains, and PP is in the darker domains. Extrusion at 250° C. can preserve the co-continuous morphology for high melt strength and sag resistance.

FIG. 7B shows the SEM image of 60:40 PET:PP pellets extruded at 230° C. (pellets from second extrusion). The co-continuous PET network is damaged, the PET domains have become larger, and PP has free channels to flow out. PET is in the white domains, and PP is in the darker domains.

Effect of second extrusion temperature on co-continuous morphology is illustrated. Extrusion can be conducted at 230° C. due to the high shear stress applied by the extruder but the PET network is damaged leading to enlargement of PET domains allowing channels for the PP melt to flow out. Thus 250 or 240° C. would be preferred for second extrusion of thick pipes, sheets etc. from PP-PET pellets.

### PC-PET Compositions

PC and PET were combined and extruded (first extrusion) at 270° C., 260° C., 250° C., 240° C., and 230° C. The PC is an amorphous polymer with only a T_{g}. The T_{g} of PC is 150° C. The density of PC is 1.22 g/cm³ and that of amorphous PET is 1.33 g/cm³, hence there is a closer density match than between PP and PET, and volume and weight ratios are closer together. For example, 50:50 by weight of PC:PET is 52.2:47.8 by volume of PC:PET.

### Morphology of PC-PET Compositions

FIG. 8 is the SEM image of a 20:80 by weight of PET-PC blend extruded at 270° C. The images show an “island in the sea” morphology. The PET is seen as spherical globules (white) within the PC matrix, in both transverse and machine direction sections of the pellets. This composition will not show Casson rheology at any temperature between the T_{g} of PC and Tₘ of PET.

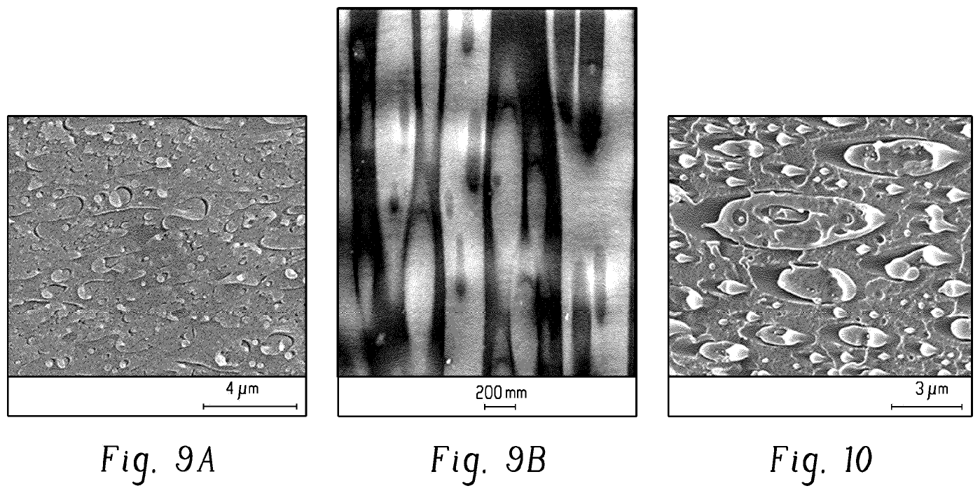

FIG. 9A shows a SEM picture, transverse view of a co-continuous morphology in a 50:50 PC:PET pellet extruded at 270° C. The start and end of domains are difficult to separate as there are interconnected inclusions of one in the other, and the contrast has become lower. FIG. 9B is a transmission electron micrograph of PC:PET blend (machine direction view of section of a pellet) where the PC has been stained with RuO₄ to enhance the contrast. In FIG. 9B, the darker area is the PC. The images show that the 50:50 PC:PET composition has a co-continuous morphology. The channels containing PC are 0.5 to 1 micrometers apart, and it is difficult for molten PC to flow between the PET domains due to capillarity forces. The compositions with the co-continuous morphology can behave like a Casson fluid at a temperature between T_{g,PC} and T_{m,PET}.

FIG. 10 is a SEM image of a 60:40 PET:PC blend extruded at 270° C., that is above the T_{m,PET}. FIG. 10 is a transverse view of the pellets, and it can appear like ‘islands in the sea’, as with the 20:80 PET-PC. However, careful inspection shows inclusions of each in the other. In the 20:80 PET-PC, spherical particles of PET (islands) are seen dispersed in a PC and the spacing is 1 to 2 micrometers; further spherical particles are also seen in the machine direction (MD) view of the pellet. In the 60:40 PET:PC blend, the interdomain distance is 250 to 500 nanometers, which makes it difficult for the melt of the lower melting material in between, to flow.

Shape Retention and Sticking Test with PC-PET Pellets

Pellets of neat PC, neat PET, and blends of PC and PET were placed in trays and heated at 200° C. or 230° C.for 10 or 30 minutes. The results are summarized Table 6.

TABLE 6

| | Completely | Light | Moderate | Strong | |
|---|---|---|---|---|---|
| Conditions | melted | sticking | sticking | sticking | No change |
| 10 min @ | PC | 60PET:40PC | 40PET:60PC | 20PET:80PC | PET, |
| 200° C. | | | | | 50PET:50PC |
| 30 min @ | PC | 60PET:40PC | 40PET:60PC | 20PET:80PC | PET, |
| 200° C. | | | | | 50PET:50PC |
| 10 min @ | PC | 50PET:50PC | 60PET:40PC | 20PET:80PC | PET |
| 230° C. | | | | 40PET:60PC | |
| 30 min @ | PC | 50PET:50PC | | 20PET:80PC | PET |
| 230° C. | | | | 40PET:60PC | |
| | | | | 60PET:40PC | |

Pellets of 50:50 PET-PC composition did not stick at 200° C. and only showed light sticking at 230° C. Pellets of 60:40 PET-PC composition showed light sticking at 200° C. and moderate sticking 230° C. Pellets of 40:60 PET-PC showed moderate sticking at 200° C. or strong sticking at 230° C. The results indicate that PET and PC blends with a weight ratio of about 2:3 to about 3:2 can behave as Casson fluids at a temperature between T_{m,PET} and T_{g,PC}.

The singular forms “a,” “an,” and “the” include plural referents unless the context clearly dictates otherwise. “Or” means “and/or” unless clearly indicated otherwise by context. Unless defined otherwise, technical and scientific terms used herein have the same meaning as is commonly understood by one of skill in the art to which this invention belongs. A “combination” is inclusive of blends, mixtures, alloys, reaction products, and the like. “One or more of the foregoing” means at least one the listed material.

Unless otherwise specified herein, any reference to standards, regulations, testing methods and the like refers to the standard, regulation, guidance or method that is in force at the time of filing of the present application.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While typical embodiments have been set forth for the purpose of illustration, the foregoing descriptions should not be deemed a limitation on the scope herein. Accordingly, various modifications, adaptations, and alternatives can occur to one skilled in the art without departing from the spirit and scope herein.

1. A method of manufacturing an article, the method comprising:
melt-mixing a first polymer with a second polymer and optionally an additive to form a thermoplastic composition,
the first polymer having a first melting point or a first glass transition temperature T₁,
the second polymer having a second melting point or a second glass transition temperature T₂ that is 30° C. to 150° C. higher than T₁,
the first polymer and the second polymer having a co-continuous morphology in the thermoplastic composition, with the second polymer providing a network for containing a melt of the first polymer; and
forming the article from the thermoplastic composition at a temperature between T₁ and T₂.

2. The method of claim 1, wherein forming the article is done via sheet extrusion, thermoforming, pipe extrusion, extrusion molding, injection molding, extrusion molding, blow molding, compression molding, or additive manufacturing,
wherein the first polymer and the second polymer have a volume ratio of 75:25 to 35:65; and
the article has a co-continuous morphology, with the second polymer providing a network for containing the first polymer.

3. The method of claim 1, wherein the thermoplastic composition has a first phase comprising the first polymer, and a second phase comprising the second polymer, and greater than 80% of the first phase and greater than 80% of the second phase are continuous as observed in an image of scanning electron microscopy or transmission electron microscopy.

4. The method of claim 1, wherein the article has a first phase comprising the first polymer, and a second phase comprising the second polymer, and greater than 80% of the first phase and greater than 80% of the second phase are continuous as observed in an image of scanning electron microscopy or transmission electron microscopy.

5. The method of claim 1, wherein the first polymer and the second polymer have a volume ratio of 70:30 to 40:60.

6. The method of claim 1, wherein T₂ is 40° C. to 120° C. higher than T₁.

7. The method of claim 1, wherein the first polymer and the second polymer are independently selected from a polyolefin, a polycarbonate, a polyester, a polyetherimide, a polyketone, a polyamide, a polyoxymethylene, and a polyacrylate.

8. The method of claim 1, wherein the first polymer comprises a polypropylene, the second polymer comprises a poly(ethylene terephthalate), and the polypropylene and the poly(ethylene terephthalate) have a volume ratio of 70:30 to 50:50.

9. The method of claim 1, wherein the thermoplastic composition comprises 0.5 to 15 wt % of the additive based on the total weight of the thermoplastic composition, the additive comprising at least one of a compatibilizer, a filler, a dye, a pigment, an antioxidant, an ultra-violet absorber, an infrared absorber, a flame retardant, a mold release agent, or an impact modifier.

10. The method of claim 1, wherein the thermoplastic composition comprises 0.5 to 15 wt % of the additive, the additive comprising a functionalized polyolefin.

11. The method of claim 1, wherein the first polymer, the second polymer, and the optional additive are mixed at a temperature that is equal to or higher than T₂ to form the thermoplastic composition.

12. The method of claim 1, wherein forming the article comprises extruding or molding the thermoplastic composition at a temperature that is between T₂−5° C. and T₂−30° C. to form a preform.

13. The method of claim 12, wherein the preform is processed at a temperature of T₁+10° C. to T₁+50° C. to form the article.

14. An article manufactured by the method of claim 1.

15. The article of claim 13, wherein the article is a Casson fluid, exhibiting no flow at low shear rates below a critical shear rate and a shear thinning behavior at high shear rates above the critical shear rate.

16. The method of claim 1, wherein the article is a Casson fluid, exhibiting no flow at low shear rates below a critical shear rate and a shear thinning behavior at high shear rates above the critical shear rate.

17. A method of manufacturing an article, the method comprising:
melt-mixing a first polymer with a second polymer and 5 to 15 wt % of an additive based on the total weight of the thermoplastic composition to form a thermoplastic composition,
the first polymer having a first melting point or a first glass transition temperature T₁,
the second polymer having a second melting point or a second glass transition temperature T₂ that is 30° C. to 150° C. higher than T₁,
the first polymer and the second polymer having a co-continuous morphology in the thermoplastic composition, with the second polymer providing a network for containing a melt of the first polymer,
the additive comprising a functionalized polyolefin; and
forming the article from the thermoplastic composition at a temperature between T₁ and T₂, wherein the first polymer and the second polymer have a volume ratio of 70:30 to 40:60.

18. The method of claim 17, wherein the article has a co-continuous morphology, with the second polymer providing a network for containing the first polymer.

19. A method of manufacturing an article, the method comprising:
melt-mixing a first polymer with a second polymer and optionally an additive to form a thermoplastic composition,
the first polymer having a first melting point or a first glass transition temperature T₁,
the second polymer having a second melting point or a second glass transition temperature T₂ that is 30° C. to 150° C. higher than T₁,
the first polymer and the second polymer having a co-continuous morphology in the thermoplastic composition, with the second polymer providing a network for containing a melt of the first polymer; and
extruding or molding the thermoplastic composition at a temperature that is between T₂−5° C. and T₂−30° C. to form a preform; and
processing the preform at a temperature of T₁+10° C. to T₁+50° C. to form the article;
wherein the first polymer comprises a polypropylene, the second polymer comprises a poly(ethylene terephthalate), and the polypropylene and the poly(ethylene terephthalate) have a volume ratio of 70:30 to 50:50.

20. The method of claim 19, wherein the article has a co-continuous morphology, with the second polymer providing a network for containing the first polymer.
